(19) United States
(12) Patent Application Publication
(10) Pub. No.: US 2024/0281479 A1
(43) Pub. Date: Aug. 22, 2024

(54) Systems and Method for Domain Mapping

(71) Applicant: Fima Leshinsky, Sunny Isles Beach, FL (US)

(72) Inventor: Fima Leshinsky, Sunny Isles Beach, FL (US)

(21) Appl. No.: 18/653,748

(22) Filed: May 2, 2024

Related U.S. Application Data
(63) Continuation of application No. 18/091,358, filed on Dec. 29, 2022, now abandoned.

(51) Int. Cl. G06F 16/951; G06F 16/901; G06F 16/906; G06F 16/953; H04L 61/4511

(52) U.S. Cl. CPC G06F 16/951; G06F 16/9024; G06F 16/906; G06F 16/953; H04L 61/4511

(57) ABSTRACT

A new system and method for domain mapping. A domain is identified or targeted for applying the process of finding related domains owned by the company owning the targeted domain. In a first step, DNS record types such as SOA, MX, NS, CNAME, and TXT as well as the WHOIS, HTTP, and SSL Certificates are searched for information related to the domain and ownership. This resource record data is collected from resource records. In a second step, domain extraction occurs, where additional domain information is extracted from each of the resource records. In a third step, domain filtering occurs where the domains extracted are reviewed and identified and tagged as either being a separate provider, referred to as provider domains, not associated with the owner of the original domain, or related domains having a connection or shared ownership or otherwise belonging to the original domain.

### SEQUENCE LISTING OR PROGRAM

Not Applicable

### TECHNICAL FIELD OF THE INVENTION

The present invention relates generally to domain mapping. More specifically, the present invention relates to identifying and mapping domains belonging to the same company.

### BACKGROUND OF THE INVENTION

Domain mapping is the process of directing visitors from one site to another. It allows one to easily point domains they own to their primary hosting account. One can map subdomains (e.g., subsite.example.com) as well as subfolders (e.g., example.com/subsite) to a custom domain.

Redirecting allows one to point multiple domains to one website. Domain mapping achieves the same thing, but with a key difference. Domain mapping keeps visitors on your custom domain despite the actual content residing on a different host. Setting up domain mapping can be tricky, but it offers many advantages. Domain mapping enables one to map custom domains to subdomains or subdirectories.

### Definitions

Unless stated to the contrary, for the purposes of the present disclosure, the following terms shall have the following definitions:

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

Domain mapping is deciding where visitors should be directed when they visit various pieces of a website. Domains and subdomains can be mapped directly to folders located within a web hosting account, or other websites, domains, subdomains, and other folders located under q different web hosting account owned by the same company.

The Domain Name System (DNS) is a hierarchical distributed naming system for computers, services, or any resource connected to the Internet or a private network. It associates various information with domain names assigned to each of the participating entities. Most prominently, it translates domain names, which can be easily memorized by humans, to the numerical IP addresses needed for the purpose of computer services and devices worldwide. The Domain Name System is an essential component of the functionality of most Internet services because it is the Internet's primary directory service.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contain instructions to be executed by a computer or other equivalent device.

A “computer system” or “system” consists of hardware components that have been carefully chosen so that they work well together and software components or programs that run in the computer. The main software component is itself an operating system that manages and provides services to other programs that can be run in the computer. The complete computer is made up of the CPU, memory, and related electronics (main cabinet), all the peripheral devices connected to it and its operating system. Computer systems fall into two categories: clients and servers.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos, or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The present invention teaches a new system and method for domain mapping. The first novel steps of the present invention involve the process of finding related domains belonging to the same company. A domain is identified or targeted for applying the process of finding related domains owned by the company owning the targeted domain.

In a first step, DNS record types such as SOA, MX, NS, CNAME, and TXT as well as the WHOIS, HTTP, and SSL Certificates are searched for information related to the domain and ownership. This resource record data is collected from DNS, WHOIS, HTTP, and SSL resource records.

In a second step, domain extraction occurs, where additional domain information is extracted from each of the resource records.

In a third step, domain filtering occurs where the domains extracted are reviewed and identified and tagged as either being a separate provider, referred to as provider domains, not associated with the owner of the original domain, or related domains having a connection or shared ownership or otherwise belonging to the original domain.

Going further into detail on the method of the third step, how to separate provider domains from related domains, it is important to fix the definitions of the terms used in this patent application for the present invention. A provider domain is a domain whose domain cluster provides services to a large number of mature domain clusters (also known as companies).

In order to determine if a domain is a provider, one must first build a domain relationship graph. Only once, after the domain graph has been created, can one identify provider vs. consumer domains.

The general process of creating or building the domain relationship graph can be broken down into three steps. In a first step, each domain is associated with an online profile to determine if a domain cluster is mature or immature. In a second step, a determination is made to establish the service provider/consumer relationship between all domains. In a third step, mature clusters absorb the domains of immature clusters.

The third step for creating a domain relationship graph is further illustrated where for every immature domain luster (I) that is not a provider, add its domains (Id) to the largest mature cluster (M) it is receiving services from, that is not a provider (P).

Cluster maturity size can be established by adding 3^{rd} party domain sizing data to the cluster such as social media followers, employees, or even Alexa rank.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 is an illustration of the method for domain mapping taught by the present invention.

FIG. 2 is a flow chart illustrating the steps of the method for domain mapping taught by the present invention.

FIG. 3 is a diagram illustrating the domain relationship graph taught by the present invention.

FIG. 4 is a diagram illustrating the mature domain cluster and firmographic data sources as defined by the present invention.

FIG. 5. is a diagram illustrating a provider cluster as taught by the present invention.

FIG. 6 is a diagram illustrating where one domain, here domain A is said or found to be providing services to a second domain, domain B if/when domain A is present in one or more resource records belonging to domain B.

FIG. 7 is a diagram illustrating where a domain cluster is a provider (A), which has one or more domains providing services to many mature domain clusters.

FIG. 8 is a diagram illustrating the association between a mature cluster and an immature cluster.

FIG. 9 is a diagram illustrating how mature clusters absorb immature clusters as taught by the present invention.

FIG. 10 is a diagram illustrating the process of establishing cluster maturity size taught by the present invention.

FIG. 11 is a flow chart illustrating the process for building a domain relationship graph as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the present invention.

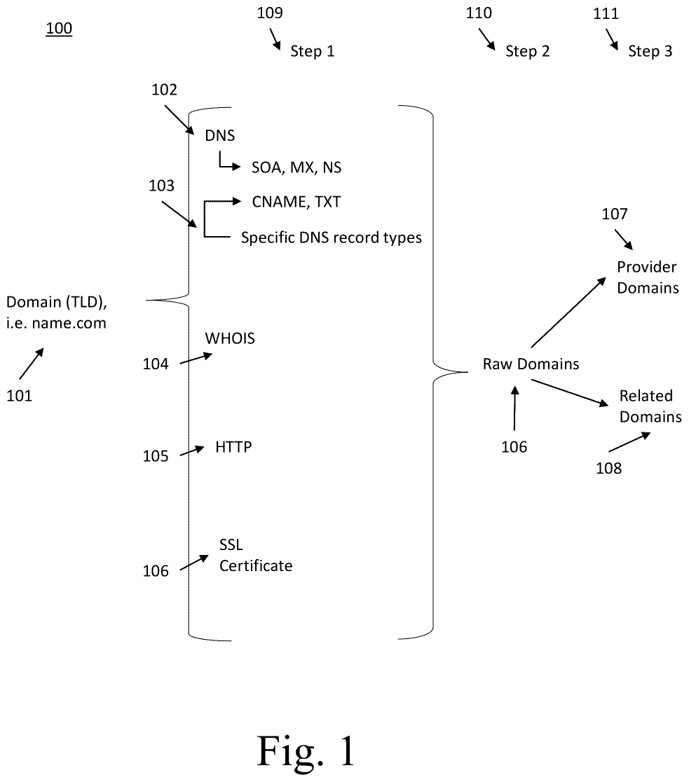

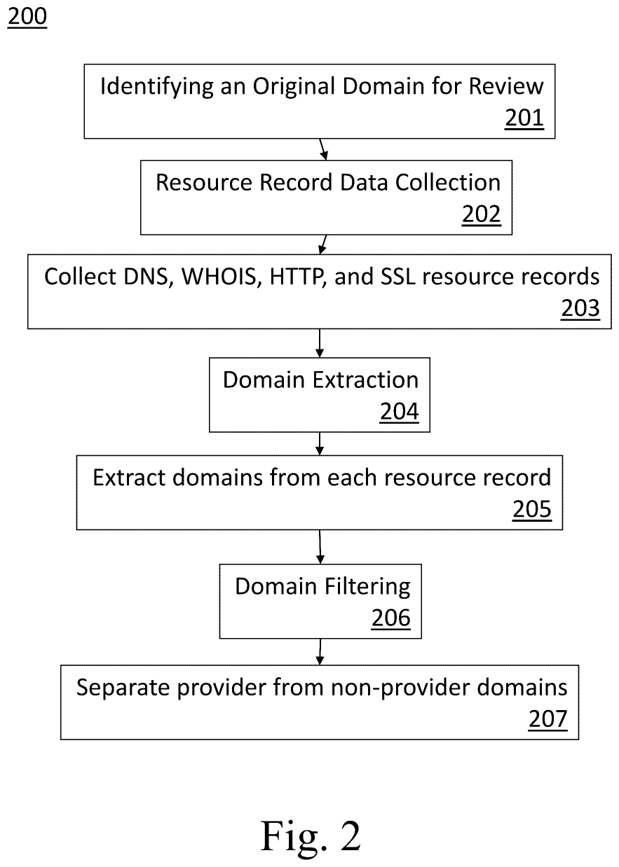

The present invention teaches a new system and method for domain mapping. Now referring to FIGS. 1-2, the three steps 109, 110, and 111 of the system and method taught by the present invention 100 are illustrated.

FIGS. 1-2 illustrate the first novel steps of present invention which involves the process of finding related domains belonging to the same company. As shown in FIG. 1 and detailed in the flow chart of FIG. 2, a domain 101 is identified or targeted 201 for applying the process of finding related domains 108 owned by the company owning the targeted domain 101.

In the first step 109, DNS record types 102 such as SOA, MX, NS, and specific DNS record types 103 CNAME, and TXT as well as the WHOIS 104, HTTP 105, and SSL Certificates 106 are searched for information related to the domain 101 and ownership. This resource record data 202 is collected 203 from DNS 102, WHOIS 104, HTTP 105, and SSL resource records 106.

In a second step 110, domain extraction 204 occurs, where additional domain information is extracted from each of the resource records 205.

In a third step 111, domain filtering 206 occurs where the raw domains extracted 106 are reviewed and identified and tagged as either being a separate provider, referred to as provider domains 107, not associated with the owner of the original domain, or related domains 108 having a connection or shared ownership or otherwise belonging to the original domain 207.

Going further into detail on the method of the third step 111, how to separate provider domains 107 from related domains 108, it is important to fix the definitions of the terms used in this patent application for the present invention. A provider domain 107 is a domain whose domain cluster provides services to a large number of mature domain clusters (also known as companies).

In order to determine if a domain is a provider domain 107, one must first build a domain relationship graph. Only once, after the domain graph has been created, can one identify provider domains 107 vs. consumer domains.

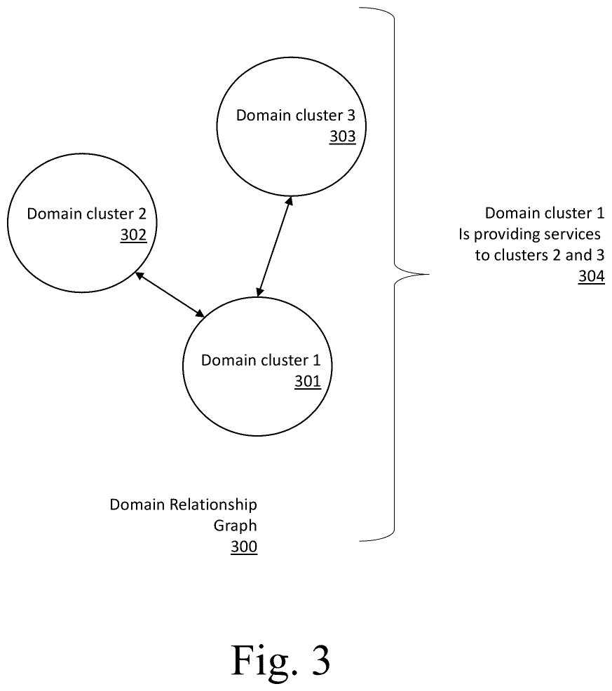

Now referring to FIG. 3, an exemplary domain relationship graph 300 is shown where a domain cluster 1 302 is providing services 304 to a second domain cluster 2 302 and a third domain cluster 3 303.

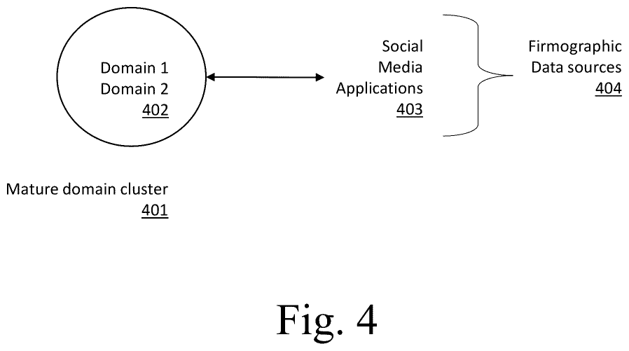

A mature domain cluster 401 is a cluster with firmographic data 404 attached. FIG. 4 illustrates a mature domain cluster 401 having a first domain and second domain 402 linked to social media applications such as TWITTER, FACEBOOK, and LINKEDIN 403, where the attachment to these social media applications 403 act as the firmographic data sources 404.

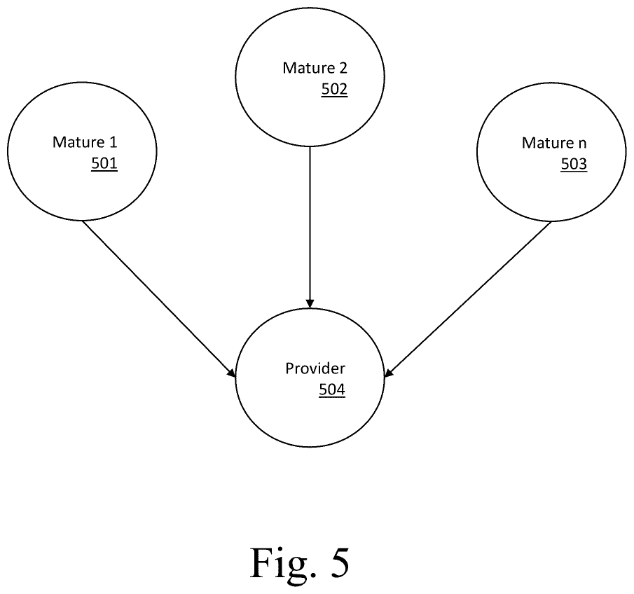

Now referring to FIG. 5, a cluster is labeled a provider 504 when the number of mature clusters 501, 502, and 503, it provides services to exceeds a defined threshold.

The instinct is to only look at a domain's relationship to other domains, but one must treat domains as belonging to a cluster of domains (a company). It is the domain cluster that is the provider and all domains belonging to the cluster are considered “provider” domains 504. This approach is novel and non-obvious over and not in alignment with the teaching or knowledge of the prior art and current mapping techniques and tactics.

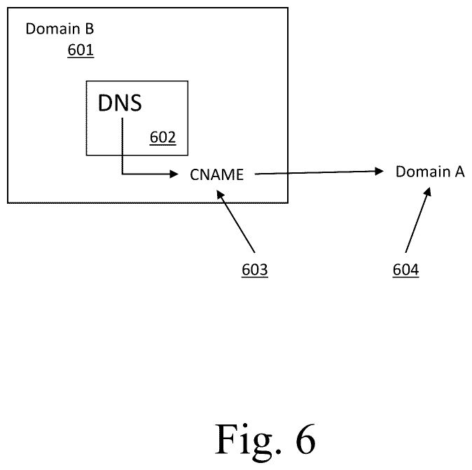

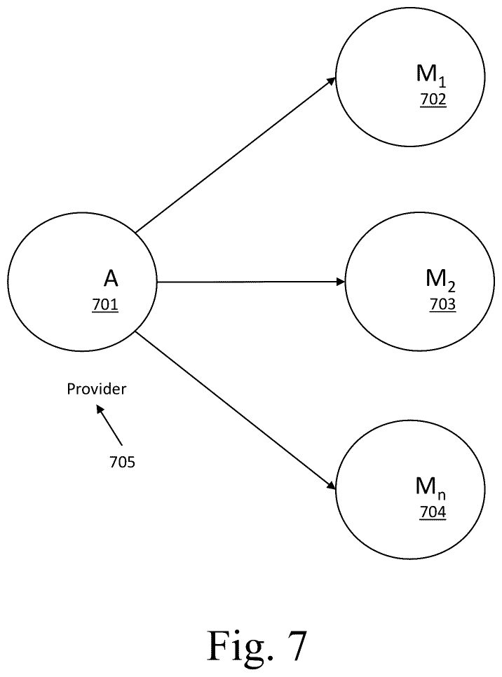

Now referring to FIGS. 6-7 the general process of creating or building the domain relationship graph is illustrated. In the exemplary situation, Domain A 604 is said to provide services to domain B 601 if domain A 604 is present in one or more DNS 602 resource records 603 as collected in step one 109 previously discussed and shown in FIGS. 1-2 belonging to domain B 601 as shown in FIG. 6.

A domain cluster is a provider (A) 701 when it has one or more domains providing services to many mature domain clusters (M1, . . . Mn) 702, 703, 704 as shown in FIG. 7.

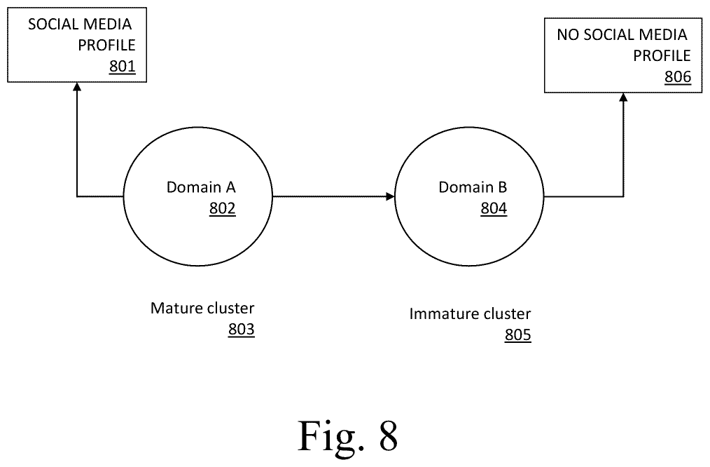

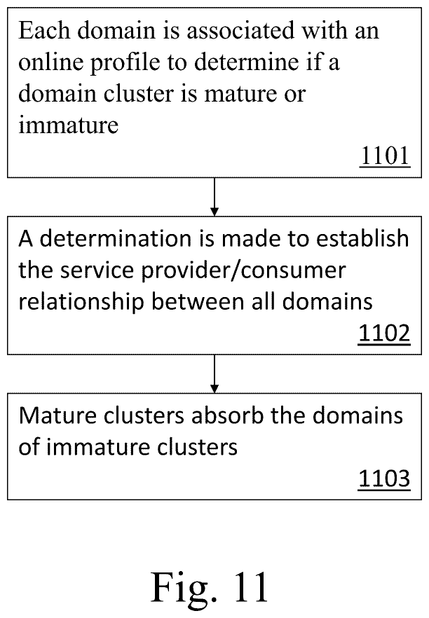

Now referring to FIG. 11, the steps for creating a domain relationship graph are further detailed. In the first step 1101, each domain 802 and 804 is associated with an online profile 801 to determine if a domain cluster is mature 803 or immature 805 as shown in FIG. 8 unless no social media profile is available 806. In a second step 1102, a determination is made to establish the service provider/consumer relationship between all domains. In a third step 1103, mature clusters 803 absorb the domains 804 of immature clusters 805.

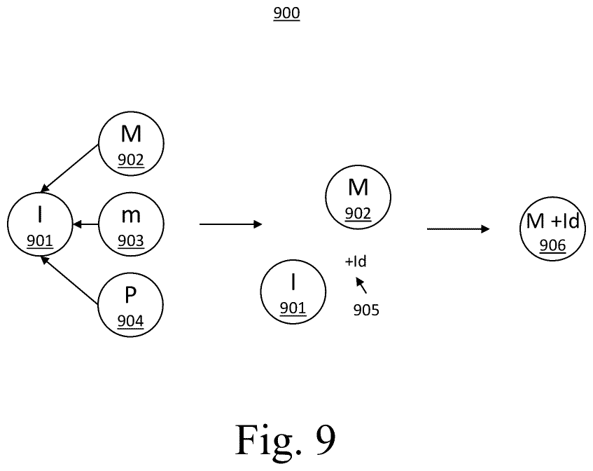

Now referring to FIG. 9, the third step 900 for creating a domain relationship graph is further illustrated where for every immature domain luster (I) 901, which is receiving services from a larger mature cluster (M), a smaller mature clusters (m) 903, and providers (P) 904, that is not a provider 904, add its domains (Id) 905 to the largest mature cluster (M) 902 it is receiving services from, that is not a provider (P) 904. The resulting cluster is then a combination of the largest mature cluster (M) and the domains (Id) 906.

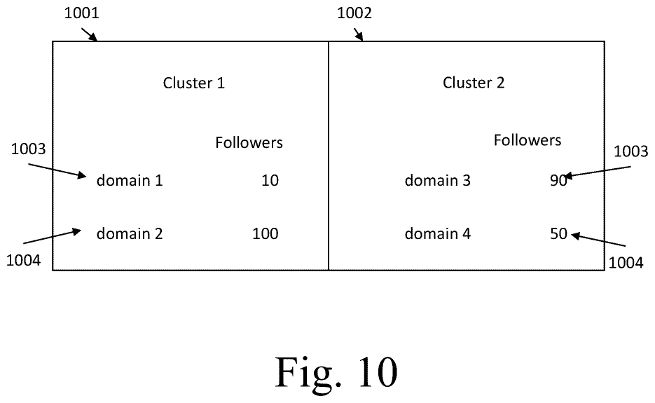

Cluster maturity size can be established by adding 3^{rd} party domain sizing data 1003 and 1004 to the clusters 1001 and 1002 such as social media followers 1003 and 1004, employees, or even ALEXA rankings as shown in FIG. 10.

The system is set to run on a computing device or mobile electronic device. A computing device or mobile electronic device on which the present invention can run would be comprised of a CPU, Hard Disk Drive, Keyboard, Monitor, CPU Main Memory, and a portion of main memory where the system resides and executes. Any general-purpose computer, smartphone, or other mobile electronic device with an appropriate amount of storage space is suitable for this purpose. Computers and mobile electronic devices like these are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A system for domain mapping comprising:
a. targeting a domain for applying a process of finding related domains owned by the company owning the targeted domain;
b. identifying a targeted domain for mapping on a computer network using a computer device;
b. the computer device connected to the computer network collecting resource record data from DNS, WHOIS, HTTP, and SSL records associated with the targeted domain;
c. the computer device extracting additional domain information from the collected resource records; and
d. the computer device filtering the extracted domains to distinguish between provider domains and related domains.

2. The system of claim 1, wherein the computer device for identifying a targeted domain utilizes DNS record types, WHOIS, HTTP, and SSL Certificates to gather information related to the domain and ownership.

3. The system of claim 1, wherein the computer device for extracting additional domain information further comprises analyzing DNS records, WHOIS data, HTTP headers, and SSL certificates associated with the targeted domain.

4. The system of claim 1, wherein the computer device for filtering the extracted domains
utilizes domain relationship graphs to differentiate between provider domains and related domains; and
the domain relationship graph comprises clusters of domains, where a provider domain is identified based on its relationship with other domains within the cluster.

5. The system of claim 1, wherein the computer device filtering the extracted domains reviews, identifies, and tags extracted domains as either being
a separate provider,
referred to as provider domains,
not associated with the owner of the original domain, or
related domains having a connection or shared ownership or otherwise belonging to the original domain.

6. The system of claim 5, wherein a provider domain is a domain whose domain cluster provides services to a large number of mature domain clusters.

7. The system of claim 5, wherein mature domain clusters are known as companies.

8. The system of claim 5, wherein the computer device builds a domain relationship graph in order to determine if a domain is a provider.

9. The system of claim 5, wherein the computer device identifies provider versus consumer domains.

10. The system of claim 5, wherein
each domain is associated with an online profile to determine if a domain cluster is mature or immature;
a determination is made to establish the service provider/consumer relationship between all domains; and
mature clusters absorb the domains of immature clusters.

11. The system of claim 5, wherein
a mature domain cluster is a cluster with firmographic data attached;
a cluster is labeled a provider when the number of mature clusters it provides services to exceeds a defined threshold; and
the domain cluster that is the provider and all domains belonging to the cluster are considered “provider” domains.

12. The system of claim 10, wherein
a domain cluster is a provider when it has one or more domains providing services to a plurality of mature domain clusters.

13. The system of claim 8, wherein creating a domain relationship graph is further defined whereby for every immature domain cluster that is not a provider, add its domains to the largest mature cluster it is receiving services from that is not a provider.

14. The system of claim 13, wherein
cluster maturity size can be established by adding 3^{rd} party domain sizing data to the cluster; and
domain sizing data includes social media followers, employees, or other 3^{rd} party or application rankings.

15. The system of claim 1, wherein the computer device for filtering identifies provider domains based on their provision of services to a large number of mature domain clusters.

16. The system of claim 15, wherein a mature domain cluster is defined as a cluster with firmographic data attached, including social media applications and other firmographic data sources.

17. The system of claim 1, wherein the computer device for filtering distinguishes between provider domains and related domains based on the number of mature clusters they provide services to.

18. A method for domain mapping comprising the steps of:
a. identifying a targeted domain for mapping;
b. collecting resource record data from DNS, WHOIS, HTTP, and SSL records associated with the targeted domain;
c. extracting additional domain information from the collected resource records; and
d. filtering the extracted domains to distinguish between provider domains and related domains based on the number of mature clusters they provide services to.

19. The method of claim 18, wherein
identifying a targeted domain involves analyzing DNS record types, WHOIS, HTTP, and SSL Certificates associated with the domain; and
extracting additional domain information includes analyzing DNS records, WHOIS data, HTTP headers, and SSL certificates.

20. The method of claim 19, wherein
provider domains are identified based on their provision of services to a large number of mature domain clusters;
a mature domain cluster is defined as a cluster with firmographic data attached, including social media applications and other firmographic data sources.
